(19) United States
(12) Patent Application Publication
(10) Pub. No.: US 2016/0158873 A1
(43) Pub. Date: Jun. 9, 2016

(54) METHOD FOR CONNECTING AT LEAST TWO SHEET METAL PARTS

(71) Applicant: AKTIENGESELLSCHAFT, Wolfsburg (DE)

(72) Inventors: Jürgen AMEDICK, Peine (DE); Marc MICHAELIS, Wolfsburg (DE); Christian SCHÜBELER, Abbesbüttel (DE)

(73) Assignee: Volkswagen Aktiengesellschaft, Wolfsburg (DE)

(21) Appl. No.: 14/908,748

(22) PCT Filed: Jul. 7, 2014
(86) PCT No.: PCT/EP2014/064484

§ 371 Date: Jan. 29, 2016

(30) Foreign Application Priority Data
Aug. 23, 2013 (DE) 10 2013 216 820.9

(51) Int. Cl. B23K 11/11; B23K 11/00

(52) U.S. Cl. CPC B23K 11/115; B23K 11/004; B23K 2201/006

(57) ABSTRACT

The invention relates to a method for connecting at least two sheet metal parts (1, 5), wherein an impressing/press-insertion element is fastened to the first sheet metal part (1) and then the impressing/press-insertion element (3) fastened to the first sheet metal part (1) is welded to the second sheet metal part (5), in particular by spot welding. According to the invention, in order to fasten the impressing/press-insertion element to the first sheet metal part (1), the impressing/press-insertion element (3) is pressed into the material of the first sheet metal part (1) in a deep-drawing direction (T) in a deep-drawing process and enters into a form-locked connection to the first sheet metal part (1) under plastic deformation.

The present invention relates to a method for joining at least two sheet metal parts according to the definition of the species set forth in claim 1 or to a sheet metal joint according to the definition of the species set forth in claim 10.

In the case of lightweight structures in the automotive sector, it is known to use aluminum-steel joints when joining a sheet-aluminum part to a sheet-steel part, for example. To join two such sheet metal parts, a steel press-insertion element can initially be driven into the sheet-aluminum part. The steel press-insertion element that is driven into the sheet-aluminum part can subsequently be joined to the sheet-steel part by spot welding.

The German Patent Application DE 10 2009 035 338 A1 describes a joining method of the species where the steel press-insertion element is placeable on a sheet-aluminum part and is drivable with a specified press-in force through the sheet-aluminum part, a stamping slug being formed. The steel press-insertion element has a widened rivet head, as well as a rivet stem. Once driven in, the steel press-insertion element projects by the rivet stem thereof with a defined portion out of the sheet-aluminum part. The end of the rivet stem projecting out of the sheet-aluminum part is then spot-welded to the sheet-steel part, in some instances with the interposition of an adhesive layer.

In the German Patent Application DE 10 2009 035 338 A1, the rivet stem of the steel press-insertion element has a cylindrical main body of solid material, which, at the end thereof facing away from the rivet head, has a conically tapered tip. Accordingly, such a complex geometry of the steel press-insertion element is expensive to manufacture. Moreover, it is necessary to consider the orientation of the press-insertion elements upon introduction thereof to the sheet metal part.

It is an object of the present invention to provide a method for joining sheet metal parts that readily ensures a satisfactory joining strength.

The objective is achieved by the features of claim 1 or of claim 10.

In accordance with the characterizing portion of claim 1, the press-insertion element is not fastened to a first sheet metal part in a riveting process, rather in a deep-drawing process where the press-insertion element is pressed into the material of the first sheet metal part in a deep-drawing direction. In the process, the first sheet metal part is deep drawn. At the same time, the press-insertion element forms a positive connection with the first sheet metal part under plastic deformation. The first sheet metal is preferably an aluminum sheet. Likewise possible are cast alloys of aluminum and/or magnesium, magnesium sheets and other ductile, as well as electrically conductive materials.

The method according to the present invention for joining preferably aluminum and steel is, therefore, carried out in two mutually independently executed process steps. In the first process step, a simply configured metallic auxiliary joining element (i.e., the press-insertion element) is press-inserted/forced/pressed into the first sheet metal part (i.e., of aluminum material), the press-insertion element being shaped to produce a form fit and a frictional fit between the element and the aluminum material that forms a connection between the aluminum and the element that is not able to be nondestructively separated. By adapting the tool geometries used for that purpose (punch/stamp and die geometry), the element region that projects out of the aluminum material and supports the subsequent, second process step may additionally be shaped to produce a connection to a component assembly.

In the second process step, the component of aluminum material is welded by way of the element region projecting out of the component surface to a steel component using a standard spot welding technique. A substance-to-substance bond is thereby formed between the press-insertion element and the steel sheet. It is also possible to weld a plurality of steel sheets to the element or directly join a plurality of materials using the press-insertion element, to then subsequently weld these to one or a plurality of steel components. The weldability may be improved by suitably forming the projecting portion of the element.

Press-insertion element welding may be combined with adhesive bonding and, in many joining cases, it is necessary in order to improve the joining properties. As a fastening method, the process of joining the components to one another using press-insertion element welding is used for applications in combination with adhesive agent, in particular with what is generally referred to as high-strength structural adhesives. In this context, the main objective of the fastening method is attaching the components to one another until adhesive curing has taken place, for example in the case of auto body bonding using heat curing adhesive agents in a cathodic dip-coating continuous furnace.

The following advantages are attained by the inventive method, namely the use of a simple press-insertion process, for which it is possible to revert to existing process techniques; the use of simple element geometries, which, compared to known approaches, makes it possible to reduce costs (axially symmetric geometry, no element head, no need for curing the elements, in some instances also no coating of the elements, a simplified element feeding for the press-insertion process that may positively influence plant availability).

In addition, when introducing the element, the joining part material is advantageously not penetrated, advantages in terms of corrosion resistance, optics and surface flushness being thereby derived. The additional use of adhesive agent eliminates the need for coating the element since, following welding, the element is completely surrounded by joining part material and adhesive, whereby no corrosion-promoting medium is able to penetrate (cost reduction, improved corrosion protection). Moreover, during the press-insertion process, the element is shaped by the setting tools, so that one element length may be utilized for different joining part thicknesses (required element compression controllable by the press-insertion process). In addition, during the press-insertion process, an element contour projecting from the sheet metal material may be produced that is advantageous for the second process step, which is welding, by using a suitable punch contour of the punch end face. Moreover, joints that are flush on both sides thereof may be produced that may be suited for the indirectly visible region, i.e., the gray zone.

In accordance with the present invention, it is possible to combine press-insertion element welding with adhesive bonding and, in many joining cases, it is necessary in order to improve the joining and component assembly properties. As a fastening method, the process of joining the components using press-insertion element welding is used for applications in combination with adhesive agent, in particular with what is generally referred to as high-strength structural adhesives. The main objective of the fastening method is then attaching the components to one another until the adhesive curing has taken place, for example in the case of auto body bonding using heat curing adhesive agents in a cathodic dip-coating continuous furnace.

The press-insertion element may preferably be configured axially symmetrically about a longitudinal axis, in particular cylindrically. One simple variant also provides that the press-insertion element have identically designed end faces. These types of element geometries are simple to manufacture using a mass production process, such as massive forming and, compared to known approaches, thereby make it possible to reduce costs. Thus, the axially symmetric geometry of the press-insertion element is without an element head. Such a simple element geometry including a planar surface area results in reduced costs due to a simplified manufacturing process, a low element weight, and a facilitated element feeding. There is also no need for any costly curing of the press-insertion elements, in some instances also no coating of the elements. The length of the press-insertion elements may be coordinated with the different component thicknesses.

Electroconductive ductile materials, preferably steel alloys, may be used as materials. Al alloys are also conceivable for additional applications.

As mentioned above, the basic shape of the press-insertion elements is axially symmetric. The end faces of the press-insertion elements may be planar, cambered, concave, convex, or acute. An acute or cambered contour projecting out of the component plane offers advantages in the process of welding to the second component, in particular when adhesive agents are used. The acute or cambered contour may be produced or modified during element manufacturing or by the process of deep-drawing into the aluminum component.

The press-insertion element surface may preferably be bare (costs are reduced since the coating is eliminated). Alternatively, however, it may also be coated (to enhance corrosion resistance or to modify the friction coefficient of the element surface). In some instances, the press-insertion element surface may also be smooth, rough or rippled (thereby influencing the friction upon press-insertion and form-locking engagement with the first sheet metal part). For example, the element diameter may preferably be 2 mm to 4 mm, and the element length 1 mm to 6 mm, preferably ≧the element diameter.

The above described simple press-insertion element geometry facilitates the introduction of the element for the press-insertion process. This means that the configuration and availability of the installation are positively influenced. During the press-insertion process, the press-insertion element is shaped by the setting tools. In this context, a common element length is possible for different joining part thicknesses since the portion of the element that projects out of the component plane (preferably 0.2 mm to 0.5 mm) is adjustable as a function of the element compression which, in turn, is controllable by the press-insertion process (punch travel). In addition, the element length may also be influenced by the contour of the punching die. The form design of the element contour projecting from the sheet metal material may be selected by using a suitable punch contour of the punch end face. This is advantageous for the second process step which is welding. It is also possible to simply match the punching element geometry (diameter, length . . . ) of the punch contour and of the die contour to the requirements for different component materials and thicknesses.

The press-insertion process may be carried out in different variants that are indicated in simplified form in the following: Thus, a press-insertion element may be provided per tool stroke. In addition, the press-insertion tools (punch and die) may be integrated in a system technology with a C-bracket that may be operated in both a steady as well as a robotic state. For example, the drive may be pneumatic, pneumohydraulic, electro-hydraulic, mechanical, etc. and, in fact, have different punch velocities. The die may be permanently integrated in a component recess, and the press-insertion device (punch and hold-down device) may be separately guided by robots to the particular joining site (one die required for each point). In addition, a plurality of elements may be provided for each tool stroke, and/or a plurality of punching tools integrated in the pressing.

Upon introduction of the press-insertion element, the present invention provides that the joining part material not be penetrated and that no element head rest on the component surface. This is advantageous for an enhanced corrosion resistance, a sealing connection, as well as a reduced contact surface between the element and component materials. Moreover, there is no need for any further covering of the element in the wet portion since the press-insertion element is completely enclosed by component material. Advantages are also derived in terms of optics (i.e., suited for gray zones) and in terms of surface flushness due to a smaller interfering contour. Alternatively, a joint that is flush with the surface on both sides may facilitate the fitting of seals. In the wet portion, the additional use of adhesive agent may eliminate the need for coating the element since the element is completely surrounded by joining part material and adhesive following the welding, whereby no corrosion-promoting medium is able to penetrate (cost reduction, improved corrosion protection). Joints that are flush on both sides thereof may also be produced that may be suited for the indirectly visible region, i.e., the gray zone.

Moreover, more than two component parts may be joined to one another. For example, a plurality of components may be joined to a first subassembly by the press-insertion process of the press-insertion element (analogously to clinch riveting). The first subassembly may subsequently be welded to one or a plurality of further component parts or to a previously joined second subassembly.

The advantageous embodiments and/or refinements of the present invention explained above and/or described in the dependent claims may be used individually or, however, also in any desired combination except, for example, in cases of unique dependencies or incompatible alternatives.

The present invention and the advantageous embodiments and/or refinements thereof, as well as the associated advantages are clarified in greater detail in the following with reference to the drawing, in which:

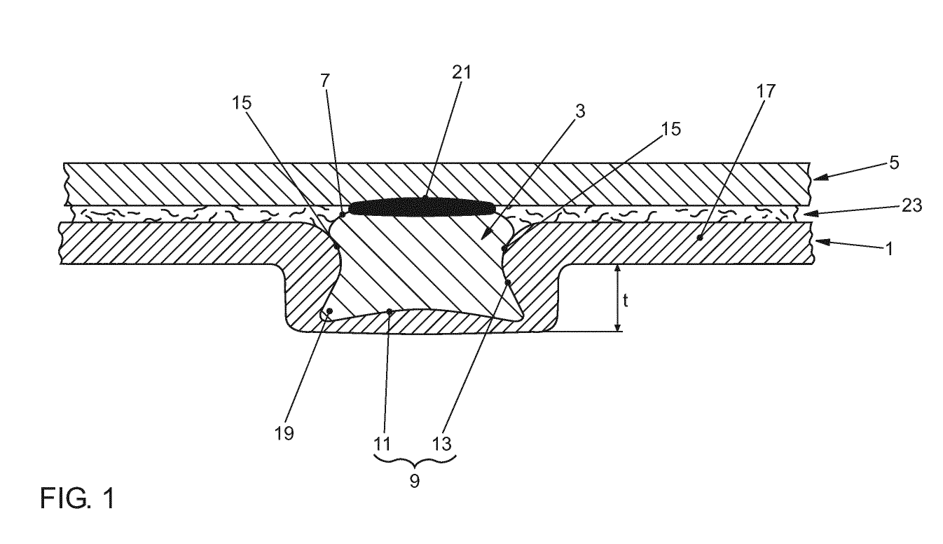

FIG. 1 shows a sheet metal joint of a sheet-steel part and of a sheet-aluminum part in a partial cross-sectional view;

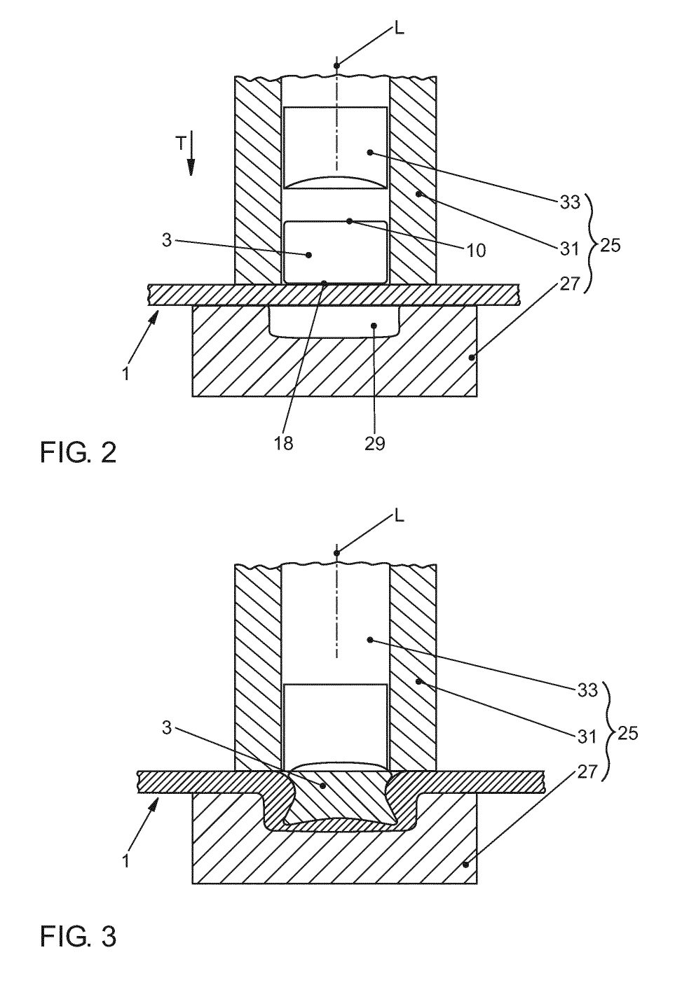

FIG. 2 through 5 each show views that illustrate the method for manufacturing the sheet metal joint;

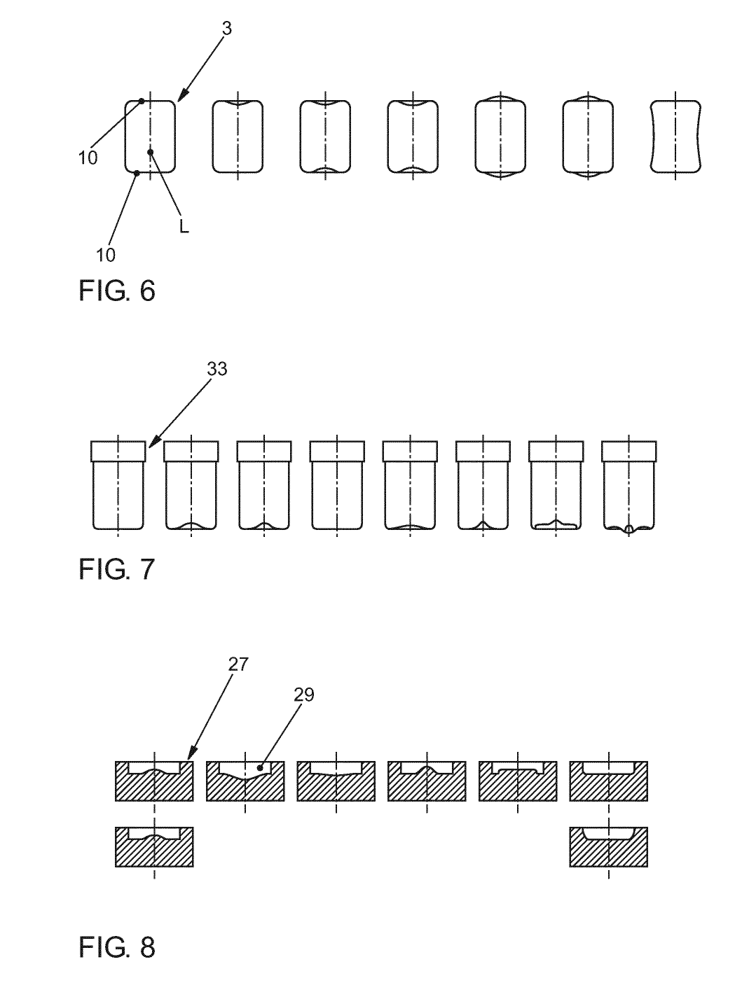

FIG. 6 shows a number of different, exemplary press-insertion element contours;

FIG. 7 shows a number of different, exemplary press ram contours; and

FIG. 8 shows a number of different, exemplary die contours.

FIG. 1 shows a sheet metal joint of a sheet-aluminum part 1 and of a sheet-steel part 5. In the case of the sheet metal joint, sheet-aluminum part 1 is joined to a sheet-steel part 5 with the aid of a steel press-insertion element 3. The illustrated aluminum-steel joint is manufactured in two steps, and, in fact, initially using a deep-drawing process in which steel press-insertion element 3 is pressed into sheet-aluminum part 1, and using a subsequent resistance spot welding where sheet-steel part 5 is welded to end 7 of press-insertion element 3 that projects out of sheet-aluminum part 1.

As is readily apparent from FIG. 1, sheet-aluminum part 1 has a deep-drawn punched depression 9 that projects downwardly approximately in a pot shape from the plane of reference of sheet-aluminum part 1. Press-insertion element 3 is forced form-fittingly into punched depression 9. Punched depression 9 is downwardly closed, i.e., without cutting through the aluminum material of sheet metal part 1. Punched depression 9 thereby has a deep-drawn bottom 11 that projects by a depth t from the bottom side of sheet-aluminum part 1, as well as a lateral wall surface 13 raised therefrom that merges at transition edges 15 into an undeformed basic section 17 of sheet-aluminum part 1. Press-insertion element 3 is forced form-fittingly into punched depression 9 in a way that presses it into an undercut projecting portion 19 (FIG. 1) formed between lateral wall surface 13 and deep-drawn bottom 11.

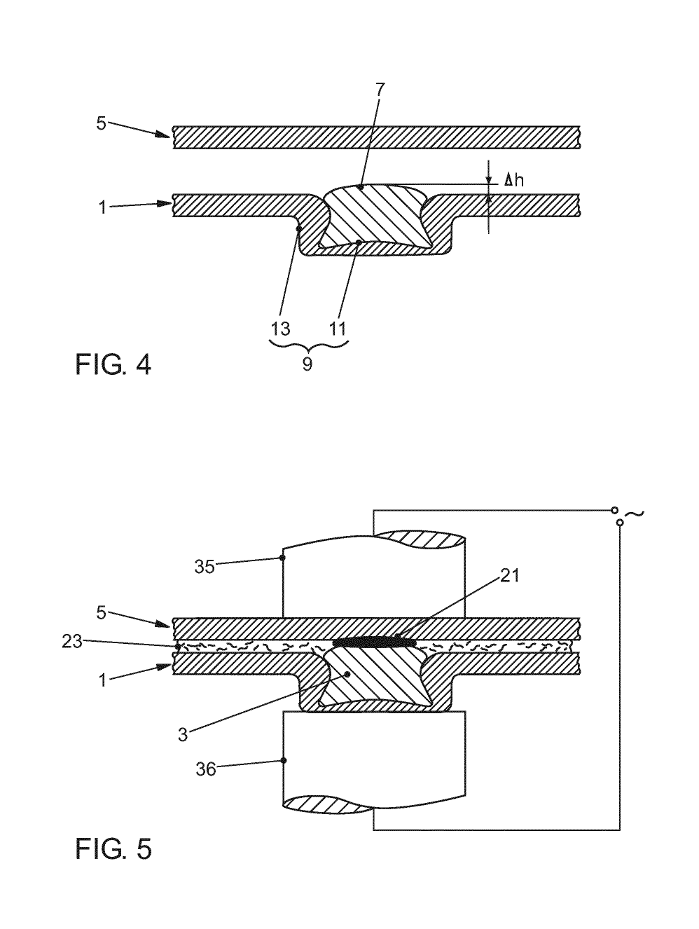

End 7 of press-insertion element 3 projecting from basic section 17 of sheet-aluminum part 1 by a height offset Δh (FIG. 4) serves as a welding attachment that is joined in a substance-to-substance bond via a schematically indicated welding lens 21 to sheet-steel part 5. Prior to the welding, both sheet metal parts 1, 5 may be provided at the mutually facing contact faces thereof with an additional adhesive layer 23.

The method for manufacturing the sheet metal joint shown in FIG. 1 is illustrated with reference to FIG. 2 through 5: Thus, in accordance with FIG. 2, sheet-aluminum part 1 and press-insertion element 3 are initially placed in a deep-drawing tool 25 composed of a bottom die 27 having an associated depression 29 and a press ram 33 guided in a guide 31. Similarly, guide 31 is used as a hold-down device that presses sheet metal part 1 onto die 27, holding it in position against the same to allow press-insertion by press-insertion element 3. Moreover, an element guide for press-insertion element 3 may be integrated in the hold-down device. Press-insertion element 3 may also be guided in the setting tool exclusively or additionally by press ram 33. During the deep-drawing process, press ram 33 is driven downwardly by a pressing stroke, whereby still undeformed press-insertion element 3 is pressed in deep-drawing direction T into the material of sheet-aluminum part 1. In the undeformed state shown in FIG. 2, press-insertion element 3 is cylindrically designed in relationship to a longitudinal, orthogonal center axis L and, in fact, identically configured at end faces 10 that are mutually opposite in the longitudinal direction.

The deep-drawing process takes place under simultaneous plastic deformation of press-insertion element 3, thereby forming a positive connection between press-insertion element 3 and sheet-aluminum part 1. Using a resistance spot welding technology, end 7 of press-insertion element 3 projecting from sheet-aluminum part 1 is subsequently brought into contact with sheet-steel part 5 and welded thereto, thereby forming welding lens 21. The two spot welding electrodes 35, 36 are thereby placed against the side of deep-drawn bottom 11 of press-insertion depression 9 facing away from press-insertion element 3 and against the side of sheet-steel part 5 facing away from press-insertion element 3, as shown in FIG. 5.

FIG. 6 through 8 show exemplarily a number of press-insertion elements 3, press rams 33 and dies 27 that have different contours. The contours may facilitate both the press-insertion process, as well as the later welding of the element. By using press rams 33 with die forms, the press-insertion element end faces projecting out of the components may be provided with curved or pointed contours, or, when already present on press-insertion element 3, they are included during the press-insertion process to protect the contour during the punching process. These end-face press-insertion element contours influence the welding process in that they serve as a contact face for the steel part. When adhesive agents are used, the force applied by welding electrodes 35, 36 may press these contours through the adhesive surface, thereby ensuring a contacting for the resistance welding.

A few possible press ram contours are shown exemplarily in FIG. 7. The diameters of press rams 33 are matched to those of the press-insertion elements and generally reside within the range of ±0.5 mm of the element diameter. Preferably, however, they equal the element diameter.

The different die contours illustrated in FIG. 8 may be used for supporting the joint formation during press-insertion. In the geometry thereof, the die contours may be adapted to the distinctive features of the joining part material into which press-insertion elements 3 are press-inserted. The die contour may also be designed as a rigid die or have movable components in the enveloping surface and/or in the bottom region. On the one hand, this makes it possible to support the material flow by the spreading of press-insertion elements 3 and, therefore, improve the load-carrying capacity of a later joint. On the other hand, the material projecting from the sheet metal plane of the joining part may be configured to be technically advantageous for the subsequent welding process and/or provide optical and/or technical advantages once the joint is produced. These advantages may reside in the contacting between sheet metal material 1, 5 and welding electrode 35, 36, be utilized for localization of the joining site (for example, when teaching welding robots, when welding using manual welding installations, when using optical systems for approach purposes), or also for reducing the interfering contours on the metal sheet surface or for visually enhancing the joint. Moreover, the die design may provide advantages upon removal of sheet metal 1 from die 27. A stripping device may also be configured at or around die 27 to support the removal process. Combinations of the die contours shown in FIG. 8 are possible in order to match the geometry to the joining task and application depending on the properties of the joining part material (for example, strength, thickness, ductility) and the properties of the joining elements (for example, geometry, strength, ductility).

1. A method for joining at least two sheet metal parts, comprising:
fastening a press-insertion element to a first sheet metal part, and
welding the press-insertion element fastened to the first sheet metal part to a second sheet metal part by spot welding,
wherein, for the fastening to the first sheet metal part, the press-insertion element is pressed in a deep-drawing process in a deep-drawing direction (T) into the material of the first sheet metal part and forms a positive connection with the first sheet metal part under plastic deformation.

2. The method as recited in claim 1, wherein the deep-drawing process takes place without cutting through the first sheet metal part.

3. The method as recited in claim 1, wherein, during the deep-drawing process, the press-insertion element is driven into the material of the first sheet metal part, forming a punched depression that merges at transition edges into a plane of reference of the sheet metal part.

4. The method as recited in claim 3, wherein the punched depression is formed in the first sheet metal part with a closed bottom and with a circumferentially extending, lateral wall surface that is raised therefrom.

5. The method as recited in claim 1, wherein the deep-drawing process takes place while forming an undercut between the deep-drawn bottom and the lateral wall surface of the punched depression (9), within which the press-insertion element is held in positive engagement.

6. The method as recited in claim 1, wherein, following the press-insertion into the first sheet metal part, the press-insertion element projects with a defined portion (Δh) out of the first sheet metal part, and the projecting end of the press-insertion element is welded to the second sheet metal part with the interposition of an adhesive layer.

7. The method as recited in claim 1, wherein, during the welding process, spot welding electrodes are placed against a side of the first sheet metal part and a side of the second sheet metal part that face away from the press-insertion element.

8. The method as recited in claim 1,
wherein the press-insertion element is fastened to the first sheet metal part in a deep-drawing tool that has a die in whose depression the first sheet metal part is deep drawn, and has a press ram that presses the press-insertion element into the first sheet metal part,
whereby the deep-drawing process takes place, and/or the press-insertion element is configured axially symmetrically about a longitudinal axis (L), in particular cylindrically, and/or the end faces of the press-insertion element, that are mutually opposite in the longitudinal direction, are identical.

9. The method as recited in claim 1, wherein the end face of the press-insertion element is deformed by an end-face contour of the press ram during/or at the end of the press-insertion process in a way that induces the projecting end to undergo a contour modification that is advantageous for the later welding process when the deformation produces a curved contour on the end face of the press-insertion element, and/or the spot welding electrodes cause such a high force to act on the joint during and/or immediately after the welding process that the depth (t) of the punched depression is minimized in order to produce a flat joint.

10. A sheet metal joint, comprising:
at least two sheet metal parts joined together by the method as recited in claim 1, a press-insertion element being fastened to the first sheet metal part, and the press-insertion element being welded to the second sheet metal part by spot welding,
wherein, to fasten the press-insertion element, the first sheet metal part has a deep-drawn punched depression into which the press-insertion element is pressed, the punched depression being produced by the pressing in of the press-insertion element.
